(19) United States
(12) Patent Application Publication
(10) Pub. No.: US 2004/0193782 A1
(43) Pub. Date: Sep. 30, 2004

(54) Nonvolatile intelligent flash cache memory

(76) Inventor: David Bordui, Lake Mary, FL (US)

Correspondence Address: Elmer W. Galbi, MARGER JOHNSON & McCOLLOM, P.C., 1030 S.W. Morrison Street, Portland, OR, 97205, US

(21) Appl. No.: 10/821,238

(22) Filed: Mar. 25, 2004

Related U.S. Application Data
(60) Provisional application No. 60/457,968, filed on Mar. 26, 2003.

(51) Int. Cl. G06F 12/00

(52) U.S. Cl. 711/103; 711/118

(57) ABSTRACT

A cache between a USB and a flash memory: The cache utilizes multiple banks of Magnetic Random Access Memory (MRAM). The size of each bank in the MRAM corresponds to the size of a sector in the flash memory. Initially, the data received from the host is stored in one of the MRAM banks. At any particular time, data destined for only one sector of the flash memory is written in each particular MRAM bank. When an MRAM bank contains as much data as the capacity of a sector, the data stored in the bank is written to the corresponding sector in the flash memory. The MRAM has a relatively high write speed and thus data can be written at the speed data is transmitted on the USB bus. Furthermore, the MRAM is a non-volatile storage device, hence, if the device is disconnected from the USB port on the host (or if power is otherwise removed), no data is lost.

### RELATED APPLICATION

This application is a non-provisional application of provisional application serial No. 60/457,968 filed Mar. 26, 2003. Priority of application 60/457,968 is hereby claimed.

### FIELD OF THE INVENTION

The present invention relates to computer memory systems and more particularly to the interface between a memory and a host.

### BACKGROUND OF THE INVENTION

The Universal Serial Bus (USB) is an interface standard that is designed to facilitate connecting a wide variety of external devices to a host computer. An important feature of the USB interface is that the USB interface is a “plug-and-play” interface. Since the USB interface is plug-and-play, when a peripheral device is plugged into a USB port, the system will auto-detect and auto-configure the device. The USB interface is also designed to eliminate the need for multiple I/O interfaces because a USB interface can handle a wide variety of devices thereby simplifying system design.

There are various versions of the USB standard. The most recent version that is in widespread use is generally termed USB 2.0. USB 2.0 can handle higher speed transfers than were possible with the prior versions of the USB standard. The USB 2.0 standard has been designed to handle speeds up to 480 Mbit per second. The USB 2.0 standard is designed so that it is backward compatible with earlier versions of the standard. Documents that define the USB standard are publicly available on the Internet and elsewhere.

USB ports can be used to connect external mass storage devices to a host system. Recently mass storage devices frequently referred to as “thumb drives” have gained widespread acceptance. Thumb drives are “thumb sized” memory devices that plug into a computer's USB port. That is, thumb drives are portable memory devices that connect to a host via a USB port. Thumb drives generally require no installation procedure. In many situations, such drives can serve as a high-capacity replacement for a floppy disk drive.

Frequently thumb drives utilize flash memory as their storage medium. There are a number of different kinds of flash memory; however, thumb drives generally utilize what is known as NAND Flash memory, and NAND flash memory will hereinafter be generally referred to as flash memory. An important feature of flash memory devices is that they can maintain stored data without any external source of power. Thus, a thumb drive can be removed from a computer without losing the data stored in the flash memory.

The read operation in a flash memory is similar to the read operation in the older and less expensive Random Access Memory (RAM); however, the write operation is handled in a different manner. In a RAM memory it is possible to write new data in individual memory locations. This is not possible in a flash memory. New data cannot be written to a location that already contains data unless the location is first erase. Furthermore, flash memories are divided into sectors and an entire sector must be erased before data can be written to any location within the sector. Thus, a relatively long time is required to write new data into a flash memory. The reason for this is that an entire sector must be first erased, and any existing data in the sector that one wants to preserve must be temporarily relocated prior to the time that the sector is erased.

The write operation into a flash memory is relatively slow and it generally involves a number of steps. The following are examples of the time required for a typical write operation in a flash memory. It should be understood that these are merely examples and a wide variety of flash memory devices exist, each with its own individual characteristics.

The first example is a ‘best case’ situation where the file size exactly matches the flash memory sector size. In most situations, this is an unlikely scenario; however, it can serve as a useful example. In this example, no partial-block movement occurs and the sector size is assumed to be 16 kilobytes (KB). In a first step, an erase sector operation is performed, taking approximately 3 milliseconds (milliseconds are hereinafter “ms”). In a second step, a write operation for 512 bytes is performed, taking approximately 25.6 microseconds (microseconds are hereinafter “us”). In a third step, a program operation for 512 bytes is performed, taking approximately 300 us. The second and third steps are then repeated 32 times for 16 KB of data which is the sector size. The total time taken for this operation is approximately 10.4 ms, giving an overall performance of:

1/(10.4 ms)*16384˜=1.57 MByte/sec˜12.6 Mbit/sec

The USB 2.0 data rate is approximately 480 Mbits/sec. Thus, the writing speed in the above example is much slower than the rate at which data can be supplied using a USB 2.0 connection.

The following is another example in which the file size does not match the flash memory sector-size. This is a more realistic example. This example requires partial-block movement operations. This example again assumes a 16KB flash sector size. In this example assume that a sector is partially filled with 8 KB of existing data and that there is a 512 byte flash buffer inside a NAND flash memory. In this example 8 KB of new data is written.

In a first step, the 8 KB of existing data are transfer to a spare sector. In a second step the spare block is erased, taking approximately 3 ms. In a third step, the 512 byte buffer is read taking approximately 25.6 us, and these 512 bytes are written into the spare sector, taking approximately 25.6 us. In a fourth step, the 512 bytes are then programmed into the spare sector, taking approximately 300 us. The third to fourth steps are repeated 16 times for 8 KB, taking a total of approximately 8.62 ms.

In another operation, the 8 KB of new data is appended to the existing data in the spare sector. In a fifth step, we write 512 Bytes, taking approximately 25.6 us. In a sixth step, we program 512 Bytes, taking approximately 300 us. The fifth and sixth steps are repeated 16 times for a total for 8 KB, taking approximately 5.21 ms.

In yet another operation, the data in the spare sector is transferred back to the original sector. In a first step, the original sector is erased taking approximately 3 ms. In a second step, 512 Bytes are read from the spare sector, taking approximately 25.6 us. In a third step, 512 Bytes are written to the original sector, taking approximately 25.6 us. In a fourth step, the original sector is programmed, taking approximately 300 us. The second to fourth steps are repeated 32 times for 16 Kbytes, taking approximately 11.24 ms.

The total time taken for the entire process is approximately 28 ms for an 8 KB data transfer. The net data rates are as follows:

1/28 ms*8192˜=293 KByte/sec=2.3 Mbit/sec

As noted previously, a USB 2.0 connection is capable of a data rate of approximately 480 Mbits/sec. Thus, the USB connection can supply data many times faster than it can be written into the flash memory in the above example.

One prior art solution for the above discrepancies in speed is to include an SRAM buffer in the interface between the USB connection and the flash memory. Data sent to the interface can then be temporarily stored in this buffer and written to the flash for permanent storage as needed. One problem that makes such a solution not particularly suitable for a thumb drive is that the SRAM is not a non-volatile memory. With such a system, if the thumb drive is removed from the system while data is still in the SRAM, the data will be lost.

The present invention provides an improved interface between a USB connection and flash memory that can, for example, be flash memory in a thumb drive.

### SUMMARY OF THE INVENTION

An improved cache is provided between a USB and a flash memory to increase storage speed. The cache utilizes multiple banks of magnetic random access memory (MRAM). The size of each bank in the MRAM is at least as large as the size of a sector in the flash memory. Initially the data received from the host is stored in one of the MRAM banks. At any particular time, data destined for only one sector of the flash memory is written in each particular MRAM bank; however, at different times, a particular MRAM bank can be associated with different flash memory sectors. When an MRAM bank has been filled with enough data to fill a sector of the flash memory, the data stored in the MRAM bank is written to a sector in the flash memory. The MRAM has a relatively high write speed and thus data can be written at the speed data is transmitted on the USB bus. Furthermore, the MRAM is a non-volatile storage device, hence if the device is disconnected from the USB port on the host (or if power is otherwise removed), no data is lost.

### BRIEF DESCRIPTION OF THE FIGURES

FIG. 1 is an overall system block diagram.

FIG. 2 is a block diagram of the interface logic.

FIG. 3 is a program flow diagram.

### DETAILED DESCRIPTION

The preferred embodiment shown herein provides an improved system for taking data from a USB and storing the data in a flash memory. The flash memory can, for example, be in a “thumb memory device” which is connected to a host by a USB connection.

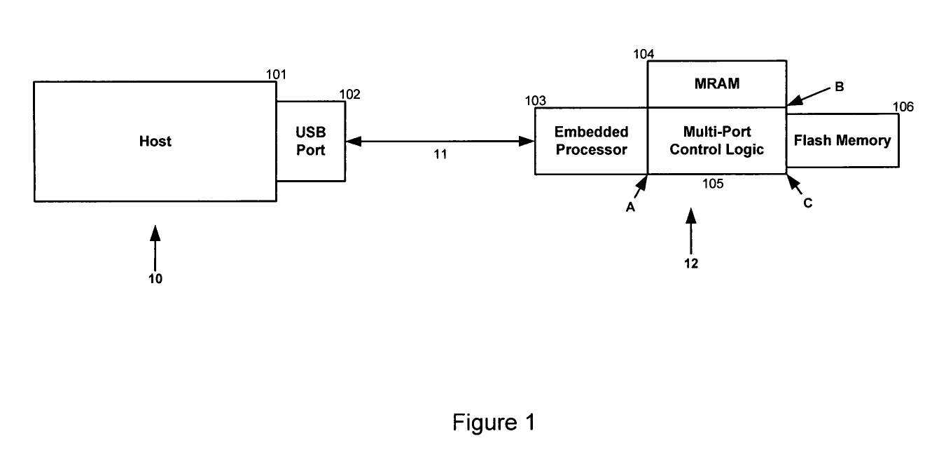

As shown in FIG. 1, a thumb memory 12 is connected to a host 10 via a USB connection 11. The host 10 has a USB port 102, which preferably conforms to the USB 2.0 standard. The host processor 101 may for example be a personal computer with a microprocessor of the type marketed by the Intel Corporation. The host 10 may be operating under an operating system such as the Microsoft Windows XP™ operating system. The Microsoft Windows XP operating system includes drivers for controlling a USB port such as USB port 102.

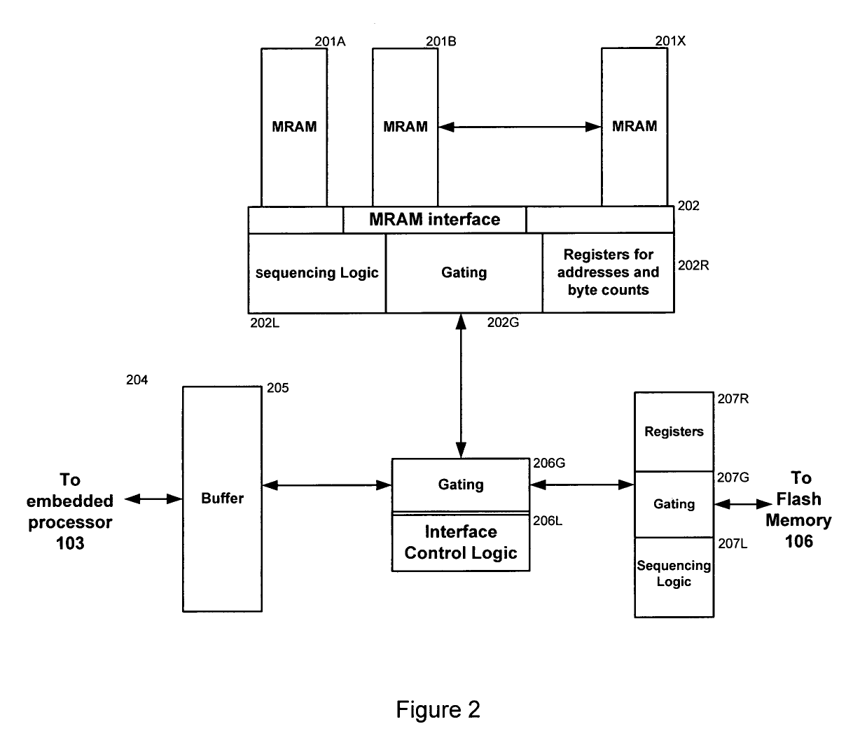

The thumb memory 12 includes an embedded processor 103, which provides an interface to the USB connection 11. The main storage device in the thumb memory 12 is the NAND flash memory 106. A magnetic random access memory 104 provides temporary storage as will be explained in detail later. Multi-port control logic 105 controls the transfer of information from embedded processor 103 to MRAM 104 and from MRAM 104 to Flash Memory 106. FIG. 2 is a block diagram of the Multi-port control Logic 105.

The cable 11 is a USB cable that conforms to the USB 2.0 standards. Data can be sent from USB port 102 to embedded processors 103. Data can also be transmitted from embedded processor 103 to USB port 102 via cable 102. However, this embodiment is concerned with improving the speed that data can be stored in Flash memory 106, hence, the following discussion will be primarily concerned with the transmission of data from USB port 102 to embedded processor 103. It is noted that embedded processors that provide an interface to a USB connection are commercially available.

The Multi-port control logic 105 has an interface “A” to embedded processor 103, an interface “B” to MRAM 104 and an interface “C” to flash Memory 106. The following is a general description of the three interfaces A, B and C.

The MRAM memory 104 consists of commercially available Magnetic Random Access Memory (MRAM) cells. MRAM does not require an additional write cycle to write data and MRAM has read and write speeds typically associated with a standard RAM memory device. Furthermore, MRAM has the additional feature of non-volatility. Thus, if the thumb drive 12 is disconnected from the host 10 while data is stored in the MRAM 104, no data will be lost. This is an important feature for a thumb drive which is designed to be easily connected and disconnected from a host.

The MRAM 104 is organized in such a manner that it mimics the size and layout of flash memory 106. That is, MRAM 104 has a number of memory banks and the size of each memory bank equals the size of a sector in flash memory 106. Alternatively, the MRAM banks 104 could be larger, but not smaller, than the size of a sector in the flash memory. However, there are less MRAM banks than there are sectors in flash memory 106. When the host 10 seeks to store an amount of data that equals only a portion of the size of a sector in flash memory 106, the data is stored in the nonvolatile MRAM prior to being transferred to the flash memory 106. Since the size of a MRAM bank is greater than or equal to the size of a flash memory sector, data can be buffered in an MRAM bank until a complete or full sector of data is available for transfer to the flash memory 106.

By employing multiple blocks of MRAM memory, a multi-level cache pipeline is established. This allows completed, full sectors of data to be written to the flash memory 106, while other MRAM blocks in the pipeline are being filled by incoming data. This configuration facilitates the use of flash memory 106 in ‘streaming’ applications, where large amounts of data are being transferred.

By balancing the number of MRAM blocks with the write-speed of flash memory 106, an almost continuous flow of data can be achieved. This is an improvement over prior art techniques which require the data source to wait while the slow flash write cycles ( and possible partial sector data movement) are performed.

The MRAM banks are provided with sequencing and gating logic (shown in FIG. 2) that allows random or sequential access of the memory locations and the data within. Control signals such as Full-Flag, Empty-Flag, etc. could be provided in order to signal the control logic to take the appropriate action.

The Multi-port control Logic 105 interfaces designated A, B and C in FIG. 1 will now be explained.

Interface A, Between Multi-Port Control Logic 105 and Embedded Processor 103:

This interface provides a data source or destination for the Multi-port Logic 105, and it is designed to be connected to an external device in order to facilitate data transfer to and from the thumb drive 12. It contains or includes the necessary input/output buffers and busses to facilitate bi-directional movement of addresses, data and control signals to and from the Multi-port control Logic 105.

Interface B from the Multi-Port Logic 105 to the MRAM 104:

This interface provides address, data, and control signal interface to the MRAM 104 cells from the Multi-Port control Logic 105. This interface would typically be a bi-directional bus/port in order to facilitate data movement to and from the MRAM. If the MRAM cells 104 are embedded in the same package or on the same die as Multi-Port control logic 105, this bus would typically be an internal bus. However, if it was desirable to have the MRAM, or other, memory devices external to the Multi-port control Logic 105, then interface B would also contain the necessary input/output buffers.

The Multi-port control Logic 105 addresses and controls the MRAM cells in a manner that allows data to be written to, and read from, various memory locations. Since multiple MRAM blocks are employed (see FIG. 2) the Multi-port control logic 105 must be able to determine and control the switching from one MRAM block to another as the block is filled. Thus interface B must keep track of data addresses, byte-counts, etc. . . . as needed in order to perform this MRAM bank switching function. These registers are shown as registers 202 R in FIG. 2. As the host writes data intended for the flash memory 106, the Multi-port control logic 105, must route the data to an available MRAM bank and location. Typically, read operations from the flash memory to the host 10 are performed directly from the flash memory 106 to the host. However, if the data being requested by the host resides in a partially filled MRAM bank the Multi-port control logic 105 keeps track of the data contained in the MRAM Bank(s) and directs the host-read request across interface B as needed.

Interface C from the Multi-port Logic 105 to the NAND Flash Memory 106:

Interface C is connected to the flash memory 106 memory which is part of the thumb drive of this embodiment. This interface transfers data to the flash memory 106 which originates at host processor 10. Interface C is a bi-directional bus which facilitates data movement to and from the flash memory 106. It contains the necessary input/output buffers and busses. This interface is configured to allow connection of flash memory with a multi-bit parallel interface (address, data, and control), or the commonly used NAND flash interface (data, control). Many high density flash memory devices utilize this type of flash interface in order to reduce the pin count that would otherwise be necessary for addressing high density memory. The interface could be configured to allow hardware or software selection of the desired flash memory interface type, sector size, etc. or alternatively it could these parameters ‘fixed’ in its logic.

The Multi-port control logic 105 must be capable of performing the necessary data movement to and from the MRAM blocks 104 and it must be capable of handling read and write operations to the attached flash memory 106. If the attached flash memory is of the NAND flash variety, as it is in this particular embodiment, then the Multi-port control logic 105 is responsible for sequencing the data and commands as needed to cause the attached NAND flash to execute the proper data movement, read, or write sequences. If in an alternate embodiment, a parallel flash memory is used, the Multi-port control logic 105 would be responsible for generating the proper address, data, and control/command sequences necessary to perform the desired operation.

The write operation from MRAM 104 to the flash memory 106 is under the control of the Multi-port control logic 105. The Multi-port control logic 105 must determine when a MRAM bank had reached the full sector capacity, and transfer the MRAM bank contents to the associated flash memory locations. While this transfer is underway, the Multi-Port control logic 105 could also allow other MRAM banks to be written concurrently by the embedded microprocessor 103, as needed.

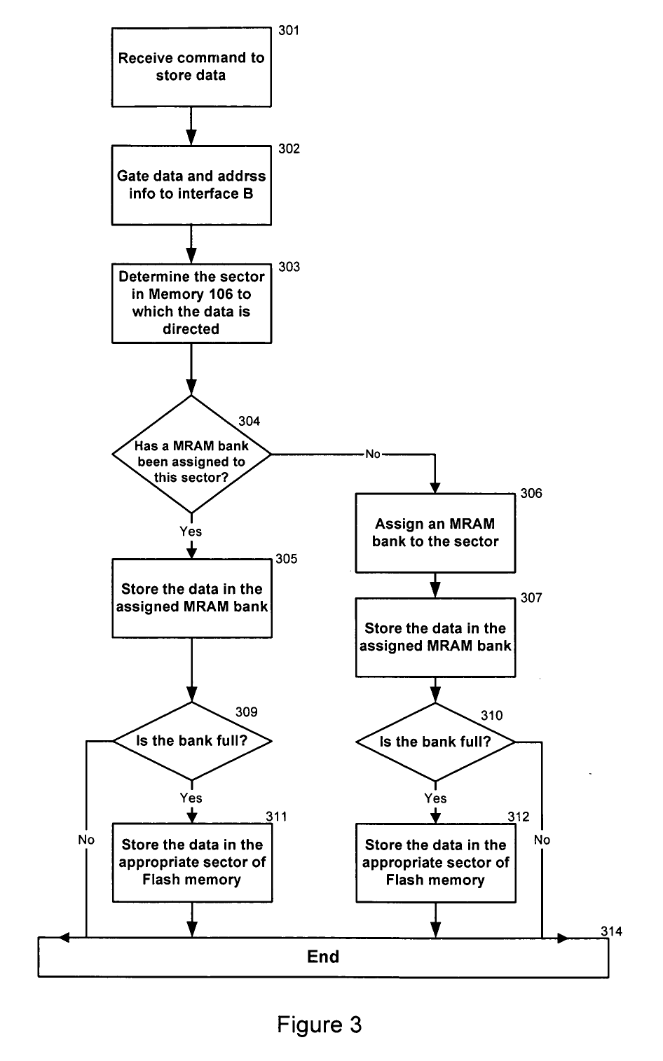

The operation of the system will be explained with reference to FIGS. 2 and 3. However, prior to discussing FIGS. 2 and 3, the following simple examples illustrate the normal operation of the system. It should be understood that there are a limitless number of different sequences that are possible. The sequences given below were chosen to illustrate the different types of operations that occur and the operation of the system is not limited to these sequences.

The following will be referenced in the following examples:

| | |
|---|---|
| A | a first sector of memory 106 |
| B | a second sector of memory 106. |
| E | another sector of memory 106. |
| F | another sector of memory 106. |
| DA | data that only fills a portion of a sector A |
| DB | addition data for sector A |
| DC | a large amount of additional data. |
| DE | data that fills sector E in flash 106. |
| DF | data that is destined for sector F in flash 106. |
| MA | an MRAM memory bank associated with sector A |
| MB | an MRAM memory bank associated with sector B |
| ME | an MRAM memory bank associated with sector E |
| MF | an MRAM memory bank associated with sector F |

To begin assume:

Flash memory 106 is completely empty and the host processor 10 sends a command over USB bus 11 to write a small amount of data (hereinafter referred to as data DA) in a small number of addresses in sector A of flash memory 106. The amount of data being written fills only a small portion of sector A in flash memory 106.

In this example, Multi-port logic 105 would realize that the data being written only constitutes a small portion of a sector. Hence, it would assign or associate one particular MRAM memory bank with the sector where data is being written. For future reference we will refer to the MRAM memory bank associated with sector A as MRAM bank “MA”. The data DA would then be written in MRAM data bank MA. This operation could occur quickly in that MRAM operates at a high speed.

To continue with this example, now assume that:

The host 10 sends a small amount of additional data (herein referred to as DB) to be written in other locations in the same sector A of the flash memory.

Multi-port control logic 105 would make two determinations. First, that the data being written is being written in memory sector A and, second, that MRAM memory bank MA has been associated with flash memory sector A. Data DB would therefore also be written in MRAM memory bank MA.

Next assume that:

The processor 10 sends a read request requesting the data DA.

The Multi-port control logic 105 will realize that the data is stored in MRAM bank MA and it will retrieve the data from MRAM bank MA and send this data to the host via interface A and embedded processor 103.

Next assume:

the host sends a relatively large amount of data for storage in the flash memory. Assume that the data hereinafter referred to as DC is destined for, and that it would fill an entire sector E in flash memory 106 plus part of another sector F. The data that fills sector E is referred to as DE and the data destined for sector F is designated DF:

The Multi-port control logic 105 will direct data DE to an empty MRAM memory bank ME and data DF to an empty MRAM memory bank hereinafter designated MF. As each MRAM data bank is filled (bank ME in this example) the data in that bank is scheduled for writing to the corresponding sector in the flash memory. During this operation, any additional incoming data for the sector is written to a different MRAM bank. The transfer of the full MRAM bank to the flash memory can occur at the same time that other data is being written to other MRAM banks. The number of operations that can occur simultaneously is a function of the size of the microprocessor (or logic) that is used to handle these operations.

FIG. 2 is a more detailed block diagram of Multi-port control logic 105 including more detail concerning the interfaces A, B and C. FIG. 2 also shows details concerning MRAM 104 including the multiple memory banks in MRAM memory 201A to 201X. Note that the number of banks of MRAM and their size is a matter of engineering choice. Only three memory banks 201A, 201B and 201X are shown in FIG. 2 for convenience of illustration. The buffers, logic, gating and registers shown in FIG. 2 are what form Multi-Port control logic 105.

The transfer of information across interfaces A, B, and C, that is, the transfer of information from embedded processor 103, MRAM 104 and flash memory 106 is controlled by interface control logic 206L which controls gates 206G. Interface control logic 206L may be hard wired logic or it can be logic performed by a program operating in embedded processor 103.

There is a buffer 205 in interface A. The buffer 205 temporarily stores data sent to the thumb drive for storage. The address in which the data is to be stored is also temporarily stored in buffer 205. The interface control logic 206L controls the gating of the data between various units. Logic 206L can be hard wired logic or it can be logic performed by a program operating in embedded processor 103. FIG. 2 shows gates 206. It should be understood that these gates may be distributed in various parts of a circuit. They are shown as a single block to facilitate illustration and explanation.

Interface B includes a unit 202 that control the operation of MRAM 104. Unit 202 includes sequencing logic 202L, gating 202G and registers 202R. Registers 202R are used to store addresses and byte counts which sequencing logic 202L needs in order to gate data to and from the correct MRAM banks. Logic 202L can be hard wired logic or it can be logic performed by a program operating in embedded processor 103.

The interface C includes a unit 207 that controls and gates information to the correct locations in flash memory 106. Unit 207 is similar to the units normally used to control the flow of information into a flash memory. Unit 207 includes flash sequencing logic 207L, gates 207G and register 207R. Registers 207R store the information needed by sequencing logic 207L to gate information to the correct place in flash memory 106. Logic 207L can be hard wired logic or it can be logic performed by a program operating in embedded processor 103.

FIG. 3 is a flow diagram of the operation of the system. The operations shown in FIG. 3 can be carried out under control of a program running in embedded processor 103 or they could be controlled by special purpose logic. The operations shown relate to transferring data from host 10 to flash memory 106. It is the time of these storage operations that is shortened by the present embodiment. Reading data for Flash memory 206 is carried out in a normal manner.

The process shown in FIG. 3 begins as indicated by block 301 when embedded processor 103 receives and decodes a command from host 10 to store certain data at specified locations in flash memory 106. Embedded processor 103 translates this information from the format used to transmit data on USB bus 11 to the format used for data in flash memory 106. Embedded processor 103 temporarily stores the information and addresses in buffer 205.

As indicated by block 302, the data and associated addresses are then gated from interface A to interface B, that is, to unit 202. The purpose of gating the information to unit 202 is so that it will be temporarily stored in one of the MRAM banks 201A to 201X.

As indicated by block 303, the data address is examined to determine the sector in memory 106 to which the data is directed. This merely involves examining the address in relationship to the beginning and end address for the sectors in memory 106. Next as indicated by block 304, a determination is made as to whether or not a MRAM bank has been associated with the particular sector to which the data is directed. If a MRAM bank has been associated with the sector, the data is stored in that MRAM bank as indicated by block 205. If an MRAM bank has not been associated with the sector, an MRAM bank is assigned to the sector as indicated by block 306 and data is stored in the assigned sector as indicated by block 308.

Next, a check is made as indicated by blocks 309 and 310 to determine if the MRAM bank into which the data has been stored is full. If the MRAM bank is full it means that there is enough data for storage in a complete sector of memory 106. If the MRAM bank is full, the associated sector in Flash memory 106 is erased and the data is transferred from the MRAM bank through interface C to flash memory 106 as indicated by blocks 311 and 312.

It is noted that the banks of MRAM memory are associated with sectors in the flash memory 106 only on a temporary basis. Once the data in an MRAM bank has been transferred to the associated sector in the flash memory, the association between-that memory bank and that sector in flash memory is finished. That MRAM bank is then available for association with a different sector as needed.

The specific preferred embodiment shown in the figures and described above relates to a thumb drive. It should be understood that various other embodiments are possible for various other types of memory devices that are connected to a host by a USB connection. For example, other embodiments are designed to increase the storage speed of other types of mass storage devices. It is also noted that the embodiment described herein utilizes NAND flash memory. Other embodiments may utilize other types of flash memory.

The embodiment described in detail herein utilizes the USB 2.0 standard. It should, however, be understood that other embodiments utilize the USB 1.0 standard. Still other embodiments utilize protocols that only partially conform to the USB 2.0 standard. Furthermore, still other embodiments utilize other types of high speed communication standards for transmitting data from the host to the embedded microprocessor.

It should be appreciated that reference throughout this specification to “one embodiment” or “an embodiment” means that a particular feature, structure or characteristic described in connection with the embodiment is included in at least one embodiment of the present invention. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the invention. Similarly, it should be appreciated that in the foregoing description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the detailed description are hereby expressly incorporated into this detailed description, with each claim standing on its own as a separate embodiment of this invention.

I claim:

1) A method storing data that is transmitted from a host to a flash memory via a bus, said method utilizing a cache memory that has banks of Magnetic Random Access Memory (MRAM), said flash memory being divided into sectors said method comprising the steps of;
associating a bank of MRAM memory with a sector to which data has been transmitted,
temporarily storing data transmitted to said flash memory in said associated bank of MRAM memory, and
transmitting data from a MRAM memory bank to the associated sector in said flash memory when said MRAM memory bank has been filed to the capacity of said sector:

2) The method recited in claim 1 wherein there are less banks of MRAM memory than there are sectors in said flash memory.

3) The method recited in claim 1 wherein said flash memory is NAND flash memory.

4) The method recited in claim 1 wherein said Flash memory and said MRAM memory are in a thumb drive.

5) The method recited in claim 1 wherein a MRAM data bank is disassociated from a sector in said flash memory when data from said MRAM bank is transmitted to the associated sector in said flash memory.

6) The method in claim 1 wherein said bus is a Universal Serial Bus (USB).

7) The method in claim 1 wherein each MRAM memory bank is at least as large as a sector in said flash memory.

8) A cache located between a bus and a flash memory, said bus transmitting data faster than the rate at which data can be directly stored in said flash memory, said flash memory being divided into sectors, said cache comprising;
a plurality of banks of Magnetic Random Access Memory (MRAM), each bank having at least a capacity equal to the size of a sector in said flash memory,
means for determining to which sector of said flash memory data is destined,
means for temporarily associating a bank of said MRAM with a sector of said flash memory to which data is destined,
means which stores data received from said USB in the associated MRAM bank, and
means which transfers data from an MRAM memory bank to the associated sector of said flash memory when said MRAM memory bank is full.

9) The cache recited in claim 8 wherein said bus is a Universal Serial Bus (USB).

10) The cache recited in claim 8 including an embedded processor that receives and decodes commands received from said serial bus.

11) The cache recited in claim 8 wherein said flash memory is NAND flash memory.

12) The cache recited in claim 8 wherein there are less banks of MRAM memory than there are sectors in said flash memory.

13) A thumb memory drive that includes the cache recited in claim 8.

14) The cache recited in claim 8 wherein a MRAM data bank is disassociated from a sector in said flash memory when data from said MRAM bank is transmitted to the associated sector in said flash memory.

15) A method of operating a cache located between a Universal Serial Bus (USB) and a flash memory, said USB transmitting data faster than the rate at which data can be stored in said flash memory, said flash memory being divided into sectors, said cache comprising;
a plurality of banks of Magnetic Random Access Memory (MRAM), each bank having a size equal to at least the size of a sector in said flash memory,
said method comprising,
determining to which sector of said flash memory data is destined,
temporarily associating a bank of said MRAM with a sector of said flash memory to which data is destined,
temporarily storing data received from said USB in the associated MRAM bank, and
transferring data from an MRAM memory bank to the associated sector of said flash memory when said MRAM memory bank is filled with an amount of data equal to the size of said sector.

16) The method recited in claim 15 wherein there are less banks of MRAM memory than there are sectors in said flash memory.

17) The method recited in claim 15 wherein said flash memory is NAND flash memory.

18) The method recited in claim 15 wherein said flash memory and said MRAM memory are in a thumb drive.

19) The method recited in claim 15 wherein a MRAM data bank is disassociated from a sector in said flash memory when data from said MRAM bank is transmitted to the associated sector in said flash memory.

20) The method recited in claim 15 wherein said cache does not lose any data if power to said cache is lost.
